(19) United States
(12) Patent Application Publication
(10) Pub. No.: US 2006/0006219 A1
(43) Pub. Date: Jan. 12, 2006

(54) Apparatus, system, and method for embossing and die-cutting

(76) Inventor: Lynda Gull, West Valley City, UT (US)

Correspondence Address: KUNZLER & ASSOCIATES, 8 EAST BROADWAY, SALT LAKE CITY, UT, 84111, US

(21) Appl. No.: 11/165,929

(22) Filed: Jun. 24, 2005

Related U.S. Application Data
(60) Provisional application No. 60/582,721, filed on Jun. 24, 2004.

(51) Int. Cl. G06K 1/00

(52) U.S. Cl. 234/42

(57) ABSTRACT

An apparatus, system, and method are disclosed for embossing, debossing, and die-cutting. The apparatus is provided with a first pressure plate, a second pressure plate, a linkage, and a lever arm. The first pressure plate is configured to cooperate with the second pressure plate to selectively emboss, deboss, and die-cut under an applied force. The linkage is linked to the first pressure plate and the second pressure plate and is configured to provide a mechanical advantage between a driver link and a driven link. The lever arm is linked to the driver link of the linkage. The lever arm is configured to provide a mechanical advantage between a distal end of the lever arm and the driver link of the linkage. Beneficially, such an apparatus, system, and method allows a user to emboss large designs in the center of standard sizes of embossable material while applying a relatively small force.

### CROSS-REFERENCES TO RELATED APPLICATIONS

This application claims benefit of U.S. Provisional Patent Application No. 60/582,721 entitled “Apparatus, System, and Method for Embossing and Die-cutting” and filed on Jun. 24, 2004 for Lynda Gull, which is incorporated herein by reference.

### BACKGROUND OF THE INVENTION

1. Field of the Invention

This invention relates to embossers and more particularly relates to portable, manual embossers.

2. Description of the Related Art

Traditionally, portable embossing machines are handheld or comparatively small devices capable of embossing and/or die cutting relatively small designs. In addition, conventional portable embossing tools restrict the positioning of the design and/or cuts to the edges of the embossable medium such as paper.

Embossing forms a raised relief design in an embossable medium such as paper, plastic, leather, foil papers, or the like. The same designs and devices that emboss are readily used to deboss. Debossing comprises forming a lowered relief design in the embossable medium. Unfortunately, embossing and debossing conventionally require a high level of pressure be applied to the design templates that are forced together by corresponding plates.

Often users of embossing tools are people who have difficulty in generating such high pressures using conventional embossing devices. Conventional embossing devices require a user to apply up to about thirty-five pounds of pressure directly to a handle of the embossing device in order to produce a satisfactory embossed design. Consequently, traditional embossing devices are kept small and provide only small embossing designs. Certain users may be incapable of producing sufficient pressure with traditional embossing devices to produce satisfactory embossings.

Conventional portable embossing machines typically consist of opposing plates connected to a single device. The device has a space or neck between the opposing plates for embossable material. The depth of this neck limits the distance from the edge of the embossable material that the device can emboss. Typically, this neck is quite short on conventional portable embossing machines; often, the embossable material is sized such that a significant portion of the center of the material cannot be reached by the conventional embossers.

From the foregoing discussion, it should be apparent that a need exists for an apparatus, system, and method for an embosser. Beneficially, such an apparatus, system, and method would allow a user to emboss large designs in the center or at various positions on standard sizes of embossable material while applying a relatively small force.

### SUMMARY OF THE INVENTION

The present invention has been developed in response to the present state of the art, and in particular, in response to the problems and needs in the art that have not yet been fully solved by currently available embossers. Accordingly, the present invention has been developed to provide an apparatus, system, and method for embossing, debossing, and die-cutting that overcome many or all of the above-discussed shortcomings in the art.

The apparatus to emboss, deboss, and die-cut is provided with a first pressure plate, a second pressure plate, a linkage, and a lever arm. The first pressure plate is configured to cooperate with the second pressure plate to selectively emboss, deboss, and die-cut under an applied force. The linkage is linked to the first pressure plate and the second pressure plate. The linkage is configured to provide a mechanical advantage between a driver link and a driven link of the linkage. The lever arm is linked to the driver link of the linkage. The lever arm is configured to provide a mechanical advantage between a distal end of the lever arm and the driver link of the linkage.

The linkage, in one embodiment, comprises a four-bar linkage. In another embodiment, the linkage comprises a slider-crank linkage. In a further embodiment, the linkage comprises a cam-follower mechanism. In yet another embodiment, the linkage comprises a gear mechanism.

The apparatus is further configured, in one embodiment, to generate a mechanical advantage between about 15:1 and about 35:1.

In a further embodiment, the apparatus may comprise one or more removable templates. The one or more removable templates may be configured to attach to the pressure plates of the apparatus. In another embodiment, the one or more removable templates may be configured to attach to the pressure plates in more than one rotational orientation. In another embodiment, the one or more removable templates may have a surface area between about four square inches and about fifteen square inches.

The one or more removable templates, in one embodiment, may further comprise orientation marks configured to indicate proper orientation of the one or more removable templates relative to each other. In another embodiment, the one or more removable templates may further comprise rule marks that indicate a position of an embossable material relative to the removable templates.

In another embodiment, the apparatus may comprise a key and a keyway configured to mate in response to proper attachment of one or more removable templates to the apparatus.

In another embodiment, the first pressure plate may be integrated with a base of the apparatus.

Another apparatus of the present invention is also presented to selectively emboss, deboss, and die-cut embossable material. The apparatus comprises a lower pressure plate and an upper pressure plate, a four-bar linkage, and a lever arm. The upper and lower pressure plates are configured to cooperate to selectively emboss, deboss, and die-cut under an applied force. The four-bar linkage may be linked to the upper pressure plate and the lower pressure plate and configured to provide a mechanical advantage between a driver link and a driven link of the four-bar linkage. The lever arm may be linked to the driver link of the four-bar linkage and configured to provide a mechanical advantage between a distal end of the lever arm and the driver link of the four-bar linkage.

The four-bar linkage may comprise a fixed link, the driver link, a coupler link, and the driven link. The apparatus may further comprise a slider-crank linkage connected to the lever arm. The mechanical advantage generated by the apparatus may increase as the pressure plates move closer together.

In another embodiment, the apparatus may include a safety latch configured to restrict relative motion of the pressure plates. The safety latch may restrict the motion of the lever arm in response to the lever arm being in an open position. The safety latch may restrict the motion lever arm in response to the lever arm being in a closed position. The safety latch may restrict movement of the lever arm in response to deactivation of the safety latch. In one embodiment, the safety latch is sized and configured such that children are unable to activate the safety latch without difficulty.

A system of the present invention is also presented to selectively emboss, deboss, and die-cut. The system may be embodied by an embossing apparatus, one or more removable templates, and embossable material. In particular, the system, in one embodiment, includes an embossing apparatus comprising a lower pressure plate and an upper pressure plate, a four-bar linkage, and a lever arm. The upper and lower pressure plates are configured to cooperate to selectively emboss, deboss, and die-cut under an applied force. The four-bar linkage may be linked to the upper pressure plate and the lower pressure plate and configured to provide a mechanical advantage between a driver link and a driven link of the four-bar linkage. The lever arm may be linked to the driver link of the four-bar linkage and configured to provide a mechanical advantage between a distal end of the lever arm and the driver link of the four-bar linkage.

The one or more removable templates may be configured to attach to the pressure plates of the apparatus. The embossable material may be configured to fit between the pressure plates and receive a design from the one or more templates.

The system may further include a neck in the fixed link of the four-bar linkage connected to a base of the embossing apparatus. The neck may form an opening having a depth between zero and about eight inches.

The system may include guides configured to facilitate accurate positioning of the embossable material relative to the lower pressure plate and the upper pressure plate. The guides may be arms attached to the embossing apparatus. The guides may further be configured to move between a storage position and a use position. In one embodiment, the guides are arms rotatably attached to the embossing apparatus. In another embodiment, the guides may further include rule marks configured to indicate distance relative to the one or more removable templates.

In one embodiment, the embossing apparatus of the system weighs between about five pounds and about twenty pounds.

An apparatus of the present invention is also presented for a template for selectively embossing, debossing, and die-cutting. The template comprises a body including a face, a design on the face, an engagement mechanism configured to removably engage a pressure plate, and a copy-protection device.

In one embodiment, the template apparatus is configured to comply with a copy protection device of an embossing apparatus. The template apparatus may be configured to attach to a pressure plate of an embossing apparatus.

In a further embodiment, the engagement mechanism may be a snap-on mechanism. In another embodiment, the engagement mechanism may be a sliding mechanism. In another embodiment, the engagement mechanism may be a fastener.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of an apparatus in accordance with the present invention;

FIG. 2 is a side view illustrating one embodiment of an apparatus according to the present invention;

FIG. 3 is a cross-section side view illustrating one embodiment of a linkage in an apparatus according to the present invention;

FIG. 4 is a cutaway side view illustrating one embodiment of a slider-crank linkage in an apparatus according to the present invention;

FIG. 5 is a cross-section, cutaway side view illustrating one embodiment of a safety latch in an apparatus according to the present invention;

FIG. 6 is a top view illustrating one embodiment of a guide in an apparatus according to the present invention; and

FIG. 7 is side view and a bottom view illustrating one embodiment of a template according to the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

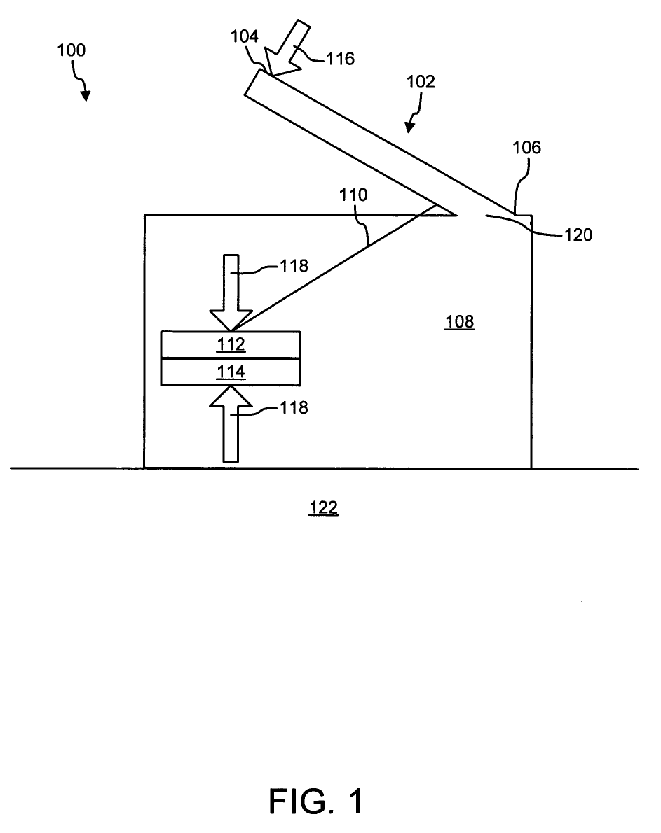

FIG. 1 illustrates a schematic block diagram of one embodiment of an apparatus 100 according to the present invention. The apparatus 100 comprises a lever arm 102 with a distal end 104 and a proximal end 106, a base 108, a linkage 110, a first pressure plate 112, and a second pressure plate 114. In response to an input force 116 (illustrated by the force arrow 116) applied to the distal end 104 of the lever arm 102, the apparatus 100 generates an output force 118 (illustrated by the force arrow 118) between the first pressure plate 112 and the second pressure plate 114.

In one embodiment, the lever arm 102 is connected to the first pressure plate 112 and transmits the input force 116 to the first pressure plate 112 through the linkage 110. The lever arm 102 may comprise any material sufficiently rigid and strong enough to transmit an input force 116 to the first pressure plate 112, such as plastic, steel, aluminum, carbon fiber, and the like.

The lever arm 102 preferably rotates around a fulcrum 120 at the proximal end 106 in response to an input force 116 applied at the distal end 104. The linkage 110 preferably connects to the lever arm 102 near the proximal end 106. The location of the connection with the linkage 110 between the location of the input force 116 at the distal end 104 and the fulcrum 120 at the proximal end 106 results in an output force 118 greater than the input force 116 being applied to the linkage 110. This increase in force is known as, and referred to herein as a “mechanical advantage.”

As will be appreciated by one skilled in the art, a variety of types and configurations of lever arm 102 may be utilized without departing from the scope and spirit of the present invention. For example, in one embodiment, the lever arm 102 may generate a mechanical advantage wherein the fulcrum 120 is between the input force 116 and the connection with the linkage 110. Preferably, the length of the lever arm 102 is such that the desired mechanical advantage is obtained.

The base 108, in one embodiment, provides a stable framework for the lever arm 102, the linkage 110, the first pressure plate 112, and the second pressure plate 114. The base 108 may be configured to rest on a flat surface 122. The base 108 may comprise any material strong and rigid enough to sustain the forces generated by the apparatus 100, such as steel, aluminum, titanium, plastic, carbon fiber, and the like.

As will be appreciated by one skilled in the art, a variety of types and configurations of base 108 may be utilized without departing from the scope and spirit of the present invention. For example, in one embodiment, the base 108 may be configured to be hand held. In another embodiment, the base 108 may be configured to me mounted to a surface with one or more fasteners (not shown).

The linkage 110, in one embodiment, is linked to the lever arm 102 and the first pressure plate 112. The linkage 110 transmits the input force 116 from the lever arm 102 to the first pressure plate 112. The linkage 110 may comprise any material strong and rigid enough to sustain the forces generated by the apparatus 100, such as steel, aluminum, titanium, plastic, carbon fiber, and the like.

The first pressure plate 112 is driven toward the second pressure plate 114 by the linkage 110 with an output force 118. An embossable material between the first pressure plate 112 and the second pressure plate 114 is embossed, debossed, or die-cut in response to the output force 118 between first pressure plate 112 and the second pressure plate 114. Alternatively, the linkage 110 connects to the second pressure plate 144 and drives the second pressure plate 114 up towards the first pressure plate 112. The first pressure plate 112 may comprise any material strong and rigid enough to sustain the forces generated by the apparatus 100, such as steel, aluminum, titanium, plastic, carbon fiber, and the like.

The second pressure plate 114 opposes the first pressure plate 112 with a normal force equal and opposite to the output force 118. The second pressure plate 114 cooperates with the first pressure plate 112 to emboss, deboss, or die-cut an embossable material. In one embodiment, the second pressure plate 114 is attached to the base 108. The second pressure plate 114 may comprise any material strong and rigid enough to sustain the forces generated by the apparatus 100, such as steel, aluminum, titanium, plastic, carbon fiber, and the like.

As will be appreciated by one skilled in the art, a variety of types and configurations of second pressure plate 114 may be utilized without departing from the scope and spirit of the present invention. For example, in one embodiment, the second pressure plate 114 is formed integral with the base 108. In another embodiment, the second pressure plate 114 is driven toward the first pressure plate 112 by a second pressure plate linkage (not shown).

The first pressure plate 112 and the second pressure plate 114 are driven together with the output force 118. In one embodiment, the apparatus 100 generates an output force 118 greater than the input force 116. The ratio of the output force 118 to the input force 116 is the overall mechanical advantage of the apparatus. In one embodiment, the overall mechanical advantage is between about 15:1 and about 35:1.

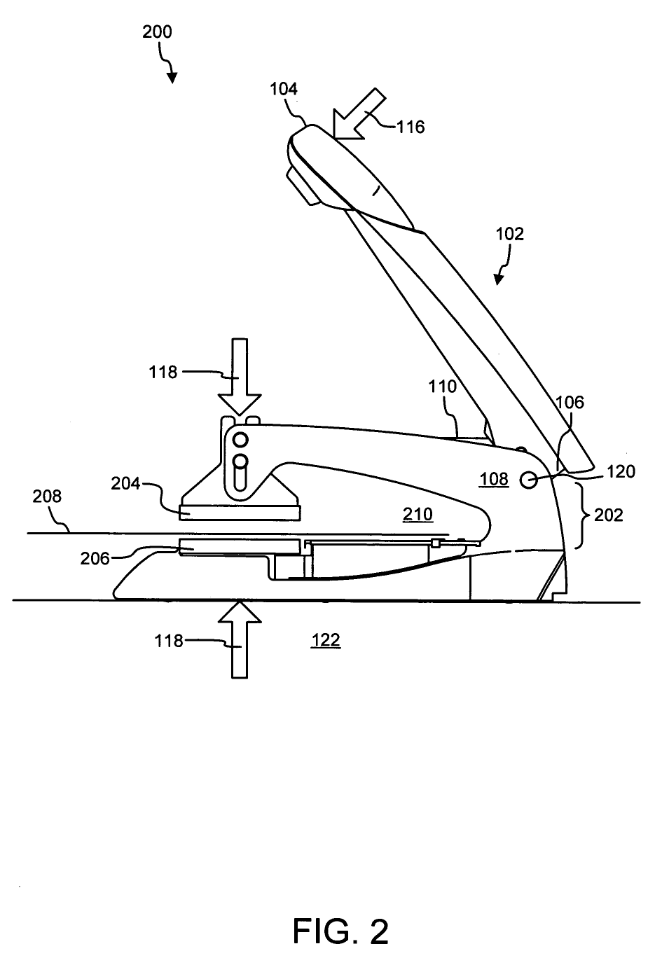

FIG. 2 illustrates one embodiment of an apparatus 200 according to the present invention. The apparatus 200 comprises a lever arm 102 with a distal end 104 and a proximal end 106, a base 108, a linkage 110, a neck 202, a top pressure plate 204, and a bottom pressure plate 206. The apparatus 200 generates an output force 118 to emboss an embossable material 208 in response to an input force 116. The lever arm 102, the base 108, the linkage 110, the input force 116, and the output force 118 are preferably configured in a manner similar to like numbered components described above in relation to FIG. 1.

The apparatus 200 is made up of a variety of components and may comprise a material, or a combination of materials, strong and rigid enough to allow the apparatus to emboss an embossable material 208. In one embodiment, the materials or composition of materials are selected such that the apparatus weighs between about five pounds and about twenty pounds.

In one embodiment, the neck 202 forms an open area 210 in the base 108 between the top pressure plate 204 and the bottom pressure plate 206. The open area 210 allows a user to position an embossable material 208 between the top pressure plate 204 and the bottom pressure plate 206 to allow embossing away from the edge of the embossable material 208. In one embodiment, the open area 210 has a depth between zero and about eight inches. An open area 210 with a depth of between zero and about eight inches allows a user to emboss embossable material 208 up to about eight inches from the edge of the embossable material 208.

The top pressure plate 204 is driven toward the bottom pressure plate 206 by the linkage 110 with an output force 118. An embossable material 208 between the top pressure plate 204 and the bottom pressure plate 206 is embossed, debossed, or die-cut in response to the output force 118 between the top pressure plate 204 and the bottom pressure plate 206. The top pressure plate 204 may comprise any material strong and rigid enough to sustain the forces generated by the apparatus 100, such as steel, aluminum, titanium, plastic, carbon fiber, and the like.

The bottom pressure plate 206 opposes the top pressure plate 204 with a normal force equal and opposite to the output force 118. The bottom pressure plate 206 cooperates with the top pressure plate 204 to emboss, deboss, or die-cut an embossable material 208. In one embodiment, the bottom pressure plate 206 is attached to the base 108. The bottom pressure plate 206 may comprise any material strong and rigid enough to sustain the forces generated by the apparatus 100, such as steel, aluminum, titanium, plastic, carbon fiber, and the like.

As will be appreciated by one skilled in the art, a variety of types and configurations of bottom pressure plate 206 may be utilized without departing from the scope and spirit of the present invention. For example, in one embodiment, the bottom pressure plate 206 is formed integral with the base 108. In another embodiment, the bottom pressure plate 206 is driven toward the top pressure plate 204 by a bottom pressure plate linkage (not shown).

The top pressure plate 204 and the bottom pressure plate 206 are driven together with the output force 118. In one embodiment, the apparatus 100 generates an output force 118 greater than the input force 116. The ratio of the output force 118 to the input force 116 is the overall mechanical advantage of the apparatus 200. In one embodiment, the overall mechanical advantage is between about 15:1 and about 35:1.

The embossable material 208 receives a design from the apparatus 200 when the design is pressed into the embossable material 208 by an output force 118. The embossable material 208 may be any material capable of deforming under the output force 118 and retaining that deformation. Examples of embossable material 208 include paper, cardboard, leather, aluminum, plastic, fabric, and the like.

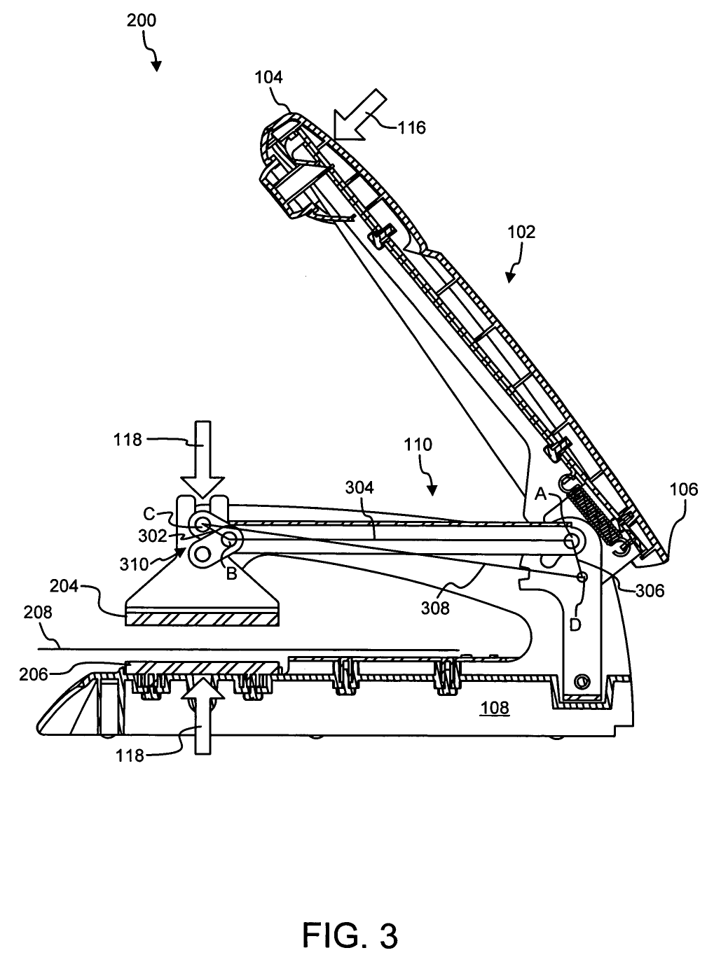

FIG. 3 illustrates one embodiment of an apparatus 200 of FIG. 2 in cross-section. The linkage 110, in one embodiment, comprises a four-bar linkage. The four-bar linkage comprises four links connected by revolute joints (Illustrated A-D), the four links include the driven link 302 from joint B to joint C, the coupler link 304 from joint A to joint B, the driver link 306 from joint A to joint D, and the fixed link 308 from joint D to joint C.

The driven link 302 is connected at joint C to the fixed link 308 and the coupler link 304 at joint B. The coupler link 304 is connected at joint B to the driven link 302 and at joint A to the driver link 306. The driver link 306 is connected at joint A to the coupler link 304 and at joint D to the fixed link 308. The driver link 306 may be attached to the lever arm 102, or may be integral with the lever arm 102. The fixed link 308 is connected at joint C to the driven link 302 and at joint D to the driver link 306. The fixed link 308 may be attached to the base 108, or may be integral with the base 108.

The revolute joints A-D at the connections of the four-bar linkage allow the connected links to rotate relative to one another. The assembly of four links into a four-bar linkage using revolute joints creates an output motion at the driven link 302 in response to an input motion at the driver link 306. The geometry of the four-bar linkage, in one embodiment, results in an output motion at the driven link 302 that is smaller than the input motion at the driver link 306.

When the output motion is less than the input motion, the output force generated at the driven link 302 is greater than the input force at the driver link 306. This resulting mechanical advantage generated by the four-bar linkage is equal to the ratio of the output force to the input force.

The driven link 302, in one embodiment, may connect to a second linkage 310. The second linkage 310 may connect to the top pressure plate 204. In an alternative embodiment, the driven link 302 may connect directly to the top pressure plate 204 without an intermediate second linkage 310. The driven link 302 drives the top pressure plate 204 and the bottom pressure plate 206 together, either directly or through the second linkage 310. As the driven link 302 drives the top pressure plate 204 and the bottom pressure plate 206 together, the ratio of the output motion to the input motion of the linkage 110 may decrease. As the ratio of the output motion to the input motion of the linkage 110 decreases, the mechanical advantage increases. This increase in mechanical advantage, as the top pressure plate 204 and the bottom pressure plate 206 come together, results in quick operation of the apparatus 300 and the application of maximum mechanical advantage as the top pressure plate 204 and the bottom pressure plate 206 apply force to the embossable material 208.

As discussed above in relation to FIG. 1, the lever arm 102 may also generate a mechanical advantage. The mechanical advantage of the lever arm 102 may be cumulative with the mechanical advantage of the linkage 110.

As will be appreciated by one skilled in the art, a variety of types and configurations of linkage 110 may be utilized without departing from the scope and spirit of the present invention. In one embodiment, the linkage 110 may comprise any linkage or series of linkages that convert the rotary motion of the lever arm 102 to linear motion of the top pressure plate 204. In general, devices that convert an input motion to an output motion are known as linkages, and there are several types of linkages known in the art. For example, in one embodiment, the linkage 110 may comprise a gear mechanism. In another embodiment, the linkage 110 may comprise a cam-follower mechanism. In a further embodiment, the linkage 110 may comprise a slider-crank mechanism.

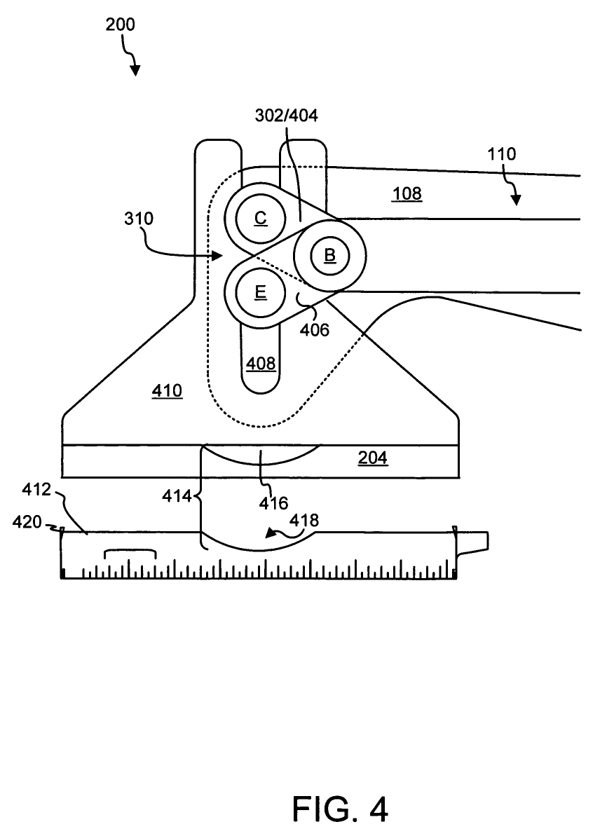

FIG. 4 illustrates a cutaway view of one embodiment of an apparatus 200 according to the present invention. The apparatus 200 further comprises a crank 302, 404, a connecting rod 406, a guide 408, a slider 410, a top pressure plate 204, one or more removable templates 412, a copy protection device 414, and an engagement mechanism 420. The apparatus 400 embosses an embossable material 208 (see FIG. 2).

The second linkage 310, in one embodiment, transmits force from the linkage 110 to the top pressure plate 204. The second linkage 310 may comprise a slider-crank linkage 310 comprising a crank 302, 404, a connecting rod 406, a guide 408, and a slider 410. The crank 302, 404 is driven by the linkage 110. In one embodiment, the crank 302, 404 may be integral with the driven link 302 of the linkage 110. The crank 302, 404 is connected to the base 108 by a revolute joint C and the connecting rod 406 by another revolute joint B. The crank 302, 404 pivots about fixed revolute joint C. The connecting rod 406 is connected to the crank 302, 404 at revolute joint B and to the slider 410 at revolute joint E. The slider 410 is connected to the connecting rod 406 by revolute joint E and slides linearly in the guide 408. The guide 408 is a channel formed in the base 108. The sliding, linear connection formed between the slider 410 and the base 108 is prismatic joint

The revolute joints at the connections of the second linkage 310 allow the connected links to rotate relative to one another. The prismatic joint formed between the slider 410 and the base 108 allow the slider 410 to translate linearly. The second linkage 310 creates an output motion at the slider 410 in response to an input motion at the crank 302, 404. The geometry of the second linkage 310, in one embodiment, results in an output motion at the slider 410 that is smaller than the input motion at the crank 302, 404.

When the output motion is less than the input motion, the output force generated at the slider 410 is greater than the input force at the crank 302, 404. This resulting mechanical advantage generated by the second linkage 310 is equal to the ratio of the output force to the input force.

As the slider 410 drives the top pressure plate 204 and the bottom pressure plate 206 together, the ratio of the output motion to the input motion of the second linkage 310 may decrease. As the ratio of the output motion to the input motion of the second linkage 310 decreases, the mechanical advantage increases. This increase in mechanical advantage as the top pressure plate 204 and the bottom pressure plate 206 come together results in quick operation of the apparatus 400 and the application of maximum mechanical advantage as the top pressure plate 204 and the bottom pressure plate 206 apply force to the embossable material 208.

As discussed above in relation to FIG. 3, the lever arm 102 and the linkage 110 may also generate a mechanical advantage. The mechanical advantage of the lever arm 102 and the linkage 110 may be cumulative with the mechanical advantage of the second linkage 310.

As will be appreciated by one skilled in the art, a variety of types and configurations of second linkage 310 may be utilized without departing from the scope and spirit of the present invention. For example, in one embodiment, the second linkage 310 may comprise a gear mechanism of one or more gears. In another embodiment, the second linkage 310 may comprise a cam-follower mechanism. In a further embodiment, the second linkage 310 may comprise a four-bar linkage.

In one embodiment, the one or more removable templates 412 may be attached to, and removed from the apparatus 200 and are forced into the embossable material 208 (see FIG. 2) by the apparatus 200 to impart a design (not shown) on the embossable material 208. The one or more removable templates 412 attach to the top pressure plate 204 or the bottom pressure plate 206.

The copy protection device 414, in one embodiment, restricts the use of one or more removable templates 412 with the apparatus 200 to those one or more removable templates 412 that comply with the copy protection device 414. The copy protection device 414 may comprise a protrusion 416 (referred to herein as a key) on the top pressure plate 204 or the bottom pressure plate 206 that mates with a matching opening 418 (referred to herein as a keyway) on compliant one or more removable templates 412.

As will be appreciated by one skilled in the art, a variety of types and configurations of copy protection device 414 may be utilized without departing from the scope and spirit of the present invention. For example, in one embodiment, the re removable template 204 includes the key 416 and the pressure plate 206,208 includes the keyway 418. In another embodiment, the copy protection device 414 comprises a proprietary shape or configuration of compliant keys and keyways.

In one embodiment, the engagement mechanism 420 removably engages the one or more removable templates 412 with the top pressure plate 204 or the bottom pressure plate 206. The engagement mechanism 420 may comprise one or more fasteners.

As will be appreciated by one skilled in the art, a variety of types and configurations of engagement mechanism 420 may be utilized without departing from the scope and spirit of the present invention. For example, in one embodiment, the engagement mechanism 420 comprises hooks on the one or more removable templates 412 that mate with an edge of the top pressure plate 204 or the bottom pressure plate 206.

In another embodiment, the engagement mechanism 420 comprises an interference fit between a lip or one or more tabs and the one or more removable templates 412 and the top pressure plate 204 or the bottom pressure plate 206. In another embodiment, the engagement mechanism 420 comprises a close tolerance fit between walls of the one or more removable templates 412 and the top pressure plate 204 or the bottom pressure plate 206. In yet another embodiment, the engagement mechanism 420 comprises a snap on mechanism between the one or more removable templates 412 and the top pressure plate 204 or the bottom pressure plate 206. In another embodiment, the engagement mechanism 420 comprises a slide on mechanism between the one or more removable templates 412 and the top pressure plate 204 or the bottom pressure plate including guides (not shown) and rails (not shown).

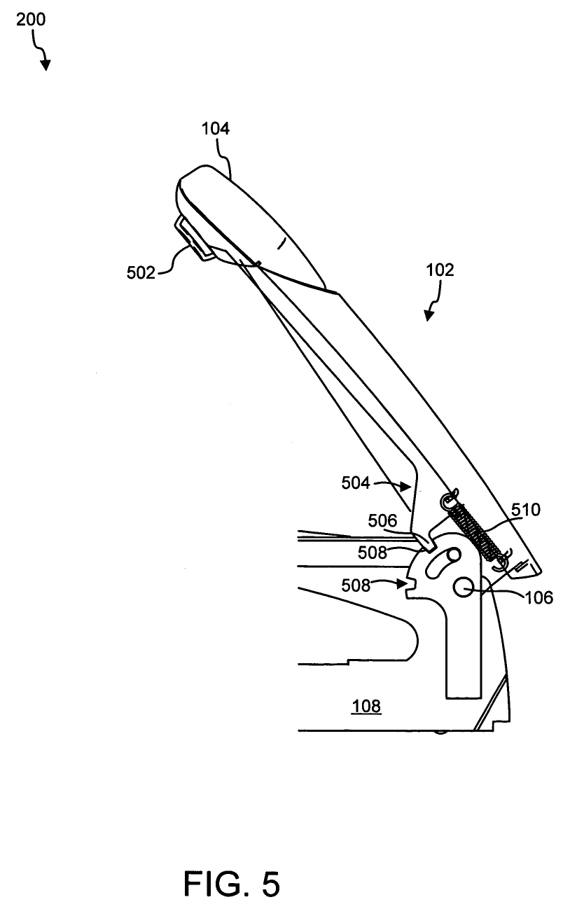

FIG. 5 illustrates a cutaway view of one embodiment of an apparatus 200 according to the present invention. The apparatus 200 comprises a safety switch 502 coupled to a safety latch 504. In one embodiment, the safety switch 502 acts on the safety latch 504 to allow rotation of the lever arm 102 relative to the base 108. The safety latch 504 may be activated by activation of the safety switch 502. The safety switch 502 may comprise a button on the lever arm 102 near the distal end 104 of the lever arm 102. The safety switch 502 may be sized such that the switch 502 is difficult for a child to activate.

The safety latch 504, in one embodiment, restricts movement of the lever arm 102 when deactivated. The safety latch 504 is preferably connected to the lever arm 102. The safety latch 504 may comprise a pawl 506 configured to engage one or more stops 508 connected to the base 108. The pawl 506 may engage the one or more stops 508 when the safety latch 504 is deactivated to restrict motion of the lever arm 102. The pawl 506 may connect to a biasing member 510 such as a spring 510. The spring 510 forces the pawl into a stop 508. Activating the safety switch 502 may retract the safety latch 504 which removes the pawl 506 from a stop 508 and increase bias in the spring 510. In one embodiment, the stop 508 restricts motion of the lever arm 102 in an open position that separates the pressure plates (not shown). Another stop 508 may restrict motion of the lever arm 102 in a closed position in which the pressure plates have been brought together. The safety latch 504 may be made from any material strong, durable, and rigid enough to restrict motion of the lever arm 102, such as steel, titanium, aluminum, carbon fiber, and the like.

As will be appreciated by one skilled in the art, a variety of types and configurations of safety latch 504 may be utilized without departing from the scope and spirit of the present invention. For example, in one embodiment, the safety latch 504 automatically engages a stop 508 in response to a repositioning of the lever arm 102. In a further embodiment, the safety latch 504 comprises a pawl 506 on the base 108 that is preferably positionable between the pressure plates (not shown) to restrict the motion of the pressure plates (not shown). In yet another embodiment, the safety latch 504 restricts the motion of the lever arm 102 in response to deactivation of the safety switch 502 regardless of the position of the lever arm 102.

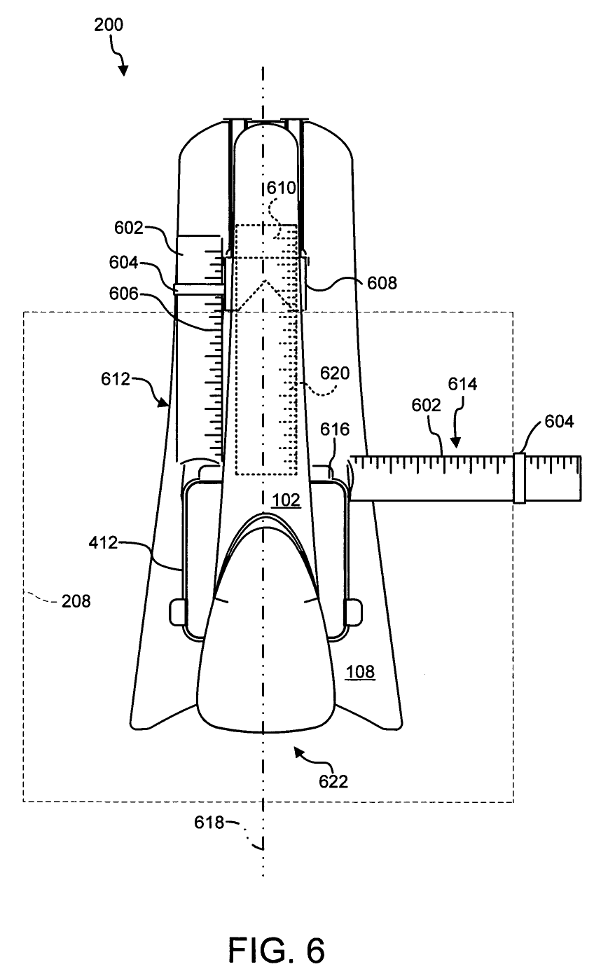

FIG. 6 illustrates one embodiment of a top view of an apparatus 200 according to the present invention. The apparatus 200 includes one or more guides 602, one or more guide stops 604, rule marks 606, a back stop 608, a back guide 610 and one or more removable templates 412. The apparatus 600 embosses embossable material 208 (shown in an embossing position by phantom lines).

The one or more guides 602, in one embodiment, allow a user to accurately position embossable material 208 relative to the sides of the one or more removable templates 412. The one or more guides 602 may comprise a planar surface that extends laterally away from the sides of the apparatus 600. An embossable material 208 may be aligned with the one or more guides 602 to accurately position the embossable material 208.

The one or more guides 602 may include one or more guide stops 604. The one or more guide stops 604 receive the edge of embossable material 208 to assist in accurate and/or consistent positioning of the embossable material 208. The one or more guide stops 604 may comprise a clip that slides laterally along the one or more guides 602.

The one or more guides 602 may include rule marks 606. The rule marks 606 allow a user to accurately determine the distance of a point along the one or more guides 602 relative to the one or more removable templates 412. The rule marks 606 may be etched into the surface of the one or more guides 602 or may be printed on the surface of one or more guides 602.

As will be appreciated by one skilled in the art, a variety of types and configurations of one or more guides 602 may be employed without departing from the scope and spirit of the present invention. For example, in one embodiment the one or more guides 602 may be configured such that they have a storage position 612 and a use position 614. In another embodiment, the one or more guides 602 rotate between the storage position and the use position on pivot 616. In a further embodiment, the one or more guides 602 are removably connected to the apparatus 600 in the use position 614. In another embodiment, the one or more guides 602 telescopically extend and/or slide into the use position 614.

The back stop 608, in one embodiment, is connected to the apparatus 600 behind the one or more removable templates 412. The back stop 608 receives the edge of embossable material 208 to aid in accurate placement of the embossable material 208 relative to the one or more removable templates 412. The back stop 608 may comprise a clip configured to slide relative to the one or more removable templates 412.

As will be appreciated by one skilled in the art, a variety of types and configurations of back stop 608 may be employed without departing from the scope and spirit of the present invention. For example, in one embodiment, the back stop 608 may comprise a surface to receive embossable material 208 that is perpendicular to the centerline 618 of the base 108. A perpendicular surface on the back stop 608 allows for easy positioning of the embossable material 208 along the centerline of the base 108. In another embodiment, the back stop 608 may comprise a surface at an angle from the centerline 618 of the base 108. An angled surface on the back stop 608 allows for easy positioning of the embossable material 208 at an angle to the centerline of the base 108. In another embodiment, the back stop 608 comprises a “V” shaped surface to receive the ninety-degree corner of embossable material 208.

The back guide 610, in one embodiment, allows a user to accurately position embossable material 208 relative to the back of the one or more removable templates 412. The back guide 610 may comprise a planar surface that extends behind the back of the one or more removable templates 412. An embossable material 208 may be aligned with the back guide 610 to accurately position the embossable material 208.

As will be appreciated by one skilled in the art, a variety of types and configurations of back guide 610 may be employed without departing from the scope and spirit of the present invention. For example, in one embodiment, the back guide 610 includes rule marks 620 to allow a user to accurately determine the distance of a point along the back guide 610 relative to the one or more removable templates 412. The rule marks 620 may be etched into the surface of the back guide 610, or they may be printed on the surface of back guide 610.

In one embodiment, the apparatus 200 is configured to rest vertically on its front end 622 in a storage position. The apparatus 200 may occupy less surface space when resting on a front end 622. Consequently, the distal end 104 of the lever arm 102 and corresponding portions of the base 108 are configured to suitably balance the apparatus 200 on the front end 622.

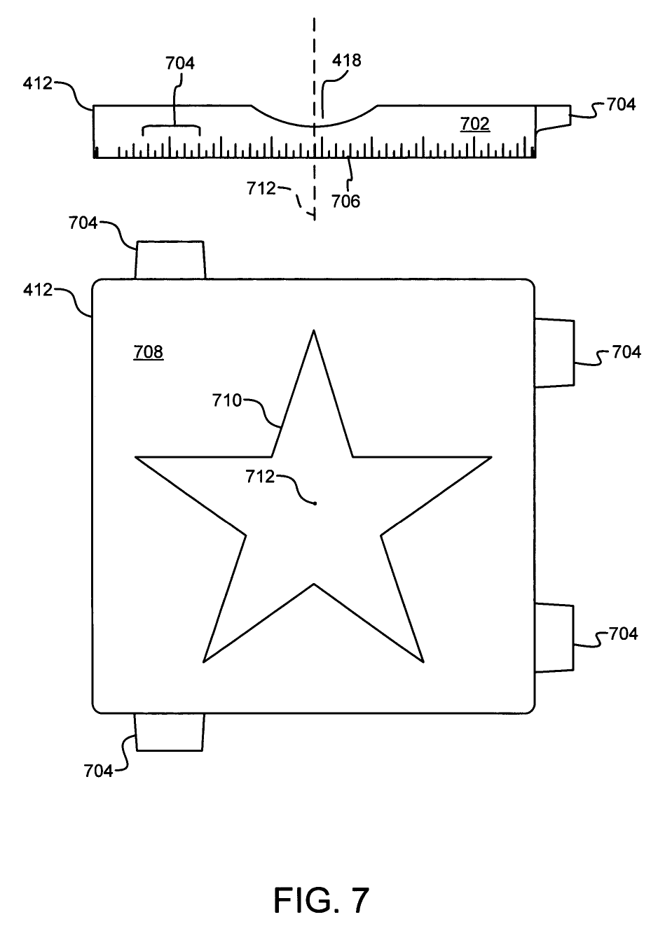

FIG. 7 illustrates one embodiment of a side view and a bottom view of one or more removable templates 412. The one or more removable templates 412 may comprise a template body 702, one or more orientation marks 704, a keyway 418, template rule marks 706, a template face 708, and a design 710. The one or more removable templates 412 impart a design on an embossable material 208 under force.

The one or more removable templates 412 may comprise a matching set of templates, with the design on one template the mirror image of the design on the other template. The matching templates cooperate to impart the design to the embossable material 208. The one or more removable templates 412 may be made from any material strong, rigid, and durable enough to emboss embossable material 208. Examples of this type of material include steel, aluminum, and polymers such as Delrin®, PTFE, and the like.

As will be appreciated by one skilled in the art, a variety of types and configurations of one or more removable templates 412 may be employed without departing from the scope and spirit of the present invention. For example, in one embodiment, the one or more removable templates 412 may comprise a matched set of two templates with a design on one template extending from the surface and complementing a design on the other template that projects into the surface. In another embodiment, the one or more removable templates 412 may comprise one template with a design and another template with no design. In a further embodiment, the one or more removable templates 412 may comprise a single template with a design, the template configured to cooperate with a pressure plate to emboss the design on the embossable material 208. In another embodiment, the one or more removable templates 412 are configured to die-cut wherein the embossable material 208 is cut by the design 710 in response to applied force by the one or more removable templates

The template body 702, in one embodiment, provides a foundation for the other elements of the template. The template body 702 may be made from any material sufficiently strong, durable, and rigid to emboss embossable material 208, such as steel, aluminum, Delrin®, PTFE, and the like.

The template body 702 may be attached to a pressure plate 208 of an apparatus. In one embodiment, the template body 702 may be attached to the pressure plate 204, 206 in one or more rotational orientations with respect to vertical axis 712. In another embodiment, the template body 702 and the pressure plate 204, 206 may be configured such that the template body 702 may attach without a restriction in rotational orientation with respect to vertical axis 712.

The one or more orientation marks 704 allow a user to determine the proper orientation of the design 710. The one or more orientation marks 704 may comprise tabs molded into the template body 702. In an alternative embodiment, the one or more orientation marks 704 may comprise marks on the template body 702. The one or more orientation marks 704 may be configured such that when the one or more orientation marks 704 on a top template align with the one or more orientation marks 704 on a bottom template, the designs on the templates are properly aligned relative to one another.

In addition, the one or more orientation marks 704 may facilitate proper orientation of the design 710. Proper design orientation can make a difference for designs 710 that are not symmetrical such as those that include lettering or words. For example, a side of the template 204 without marks 704 may always indicate the bottom of the design 710.

The keyway 418, in one embodiment, is part of a copy protection device 414 on an apparatus 200. In one embodiment, the keyway 418 comprises a cutout on the edge of the template body 702 configured to comply with key 416 (See FIG. 4) on the apparatus 200.

The template rule marks 706 allow a user to accurately and consistently position embossable material 208 relative to the one or more removable templates 412. The template rule marks 706 may comprise marks machined on the side of the one or more removable templates 412. Alternatively, the template rule marks 706 may be printed on the side or molded into the side of the one or more removable templates 412.

The template face 708, in one embodiment, comprises a surface on the template body 702 configured to contain a design 710. The template face 708 is forced into an embossable material 208. The template face 708 may comprise a surface area from about four square inches to about fifteen square inches. This large surface area allows for the use of a large design 710.

The design 710 comprises variations in the surface of the template face 708 that raise or lower areas in the embossable material 208 during the embossing process. The design 710 may be formed integrally with the template body 702.

As will be appreciated by one skilled in the art, a variety of types and configurations of design 710 may be employed without departing from the scope and spirit of the present invention. For example, in one embodiment, the design 710 comprises material affixed to the surface of the template face 708. In another embodiment, the design 710 comprises material machined from the template face 708.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for selectively embossing, debossing, and die-cutting, the apparatus comprising:
a first pressure plate and a second pressure plate configured to cooperate to selectively emboss, deboss, and die-cut under an applied force;
a linkage linked to the first pressure plate and the second pressure plate, the linkage configured to provide a mechanical advantage between a driver link and a driven link of the linkage; and
a lever arm linked to the driver link of the linkage, the lever arm configured to provide a mechanical advantage between a distal end of the lever arm and the driver link of the linkage.

2. The apparatus of claim 1, wherein the linkage is selected from the group consisting of a four-bar linkage, a slider-crank linkage, a cam-follower, and a gear mechanism.

3. The apparatus of claim 1, wherein the mechanical advantage generated by the apparatus is between about 15:1 and about 35:1.

4. The apparatus of claim 1, further comprising one or more removable templates configured to attach to the pressure plates.

5. The apparatus of claim 4, wherein the removable templates are further configured to attach to a pressure plate in more than one rotational orientation.

6. The apparatus of claim 4, wherein each of the one or more removable templates comprise a surface area between about four square inches and about fifteen square inches.

7. The apparatus of claim 4, wherein the first pressure plate is integrated with a base of the apparatus, and wherein the removable templates further comprise orientation marks that indicate proper orientation of the removable templates relative to each other.

8. The apparatus of claim 4, wherein the removable templates further comprise rule marks that indicate a position of an embossable material relative to the removable templates.

9. The apparatus of claim 4, further comprising a key and a keyway configured to mate in response to proper attachment of a removable template to a pressure plate.

10. An apparatus for selectively embossing, debossing, and die-cutting, the apparatus comprising:
a lower pressure plate and an upper pressure plate configured to cooperate to selectively emboss, deboss, and die-cut under an applied force;
a four-bar linkage linked to the upper pressure plate and the lower pressure plate, the four-bar linkage configured to provide a mechanical advantage between a driver link and a driven link of the four-bar linkage; and
a lever arm linked to the driver link of the four-bar linkage, the lever arm configured to provide a mechanical advantage between a distal end of the lever arm and the driver link of the four-bar linkage.

11. The apparatus of claim 10, wherein the four-bar linkage comprises a fixed link, the driver link, a coupler link, and the driven link.

12. The apparatus of claim 10, further comprising a slider-crank linkage connected to the lever arm by way of the four-bar linkage configured to provide a mechanical advantage.

13. The apparatus of claim 10, wherein the mechanical advantage generated by the four-bar linkage increases as the pressure plates move together.

14. The apparatus of claim 10, further comprising a safety latch configured to restrict relative movement of the pressure plates.

15. The apparatus of claim 14, wherein the safety latch restricts movement of the lever arm in response to the lever arm being in one of an open position and a closed position.

16. The apparatus of claim 14, wherein the safety latch restricts movement of the lever arm in response to deactivation of the safety latch.

17. A system for selectively embossing, debossing, and die-cutting, the system comprising:
an embossing apparatus, the embossing apparatus comprising:
a lower pressure plate and an upper pressure plate configured to cooperate to selectively emboss, deboss, and die-cut under an applied force;
a four-bar linkage linked to the upper pressure plate and the lower pressure plate, the four-bar linkage configured to provide a mechanical advantage between a driver link and a driven link; and
a lever arm linked to the driver link of the four-bar linkage, the lever arm configured to provide a mechanical advantage between a distal end of the lever arm and the driver link of the four-bar linkage;
one or more removable templates, the templates configured to attach to the pressure plates; and
embossable material configured to fit between the pressure plates and receive a design from the one or more templates.

18. The system of claim 17, wherein a fixed link of the four-bar linkage comprises a neck connected to a base of the embossing apparatus to form an opening having a depth ranging between zero to about eight inches.

19. The system of claim 17, further comprising guides configured to facilitate accurate positioning of the embossable material relative to the lower pressure plate and the upper pressure plate.

20. The system of claim 19, wherein the guides comprise arms attached to the embossing apparatus, the guides configured to move between a storage position and a use position.

21. The system of claim 20, wherein the arms are rotatably attached to the embossing apparatus.

22. The system of claim 19, wherein the guides further comprise rule marks configured to indicate distance relative to the one or more removable templates.

23. The system of claim 17, wherein the embossing apparatus weighs between about five pounds and about twenty pounds.

24. A template for selectively embossing, debossing, and die-cutting, the template comprising:
a body including a face;
a design on the face;
an engagement mechanism configured to removably engage a pressure plate; and
a copy protection device.

25. The template of claim 24, wherein the template is configured to comply with the copy protection device and attach to a pressure plate of an embossing apparatus, the embossing apparatus comprising:
a lower pressure plate and an upper pressure plate configured to cooperate to selectively emboss, deboss, and die-cut under an applied force;
a linkage linked to the upper pressure plate and the lower pressure plate, the linkage configured to provide a mechanical advantage between a driver link and a driven link; and
a lever arm linked to the driver link of the linkage, the lever arm configured to provide a mechanical advantage between a distal end of the lever arm and the driver link of the linkage.

26. The template of claim 24, wherein the engagement mechanism is selected from the group consisting of a snap-on mechanism, a sliding mechanism, and a fastener.
